(19) United States
(12) Patent Application Publication
(10) Pub. No.: US 2011/0036032 A1
(43) Pub. Date: Feb. 17, 2011

(54) CONSTRUCTION ELEMENT

(76) Inventors: Sean Smith, Dainfern (ZA); Peter George Thorne, Gauteng (ZA)

Correspondence Address: NIXON PEABODY, LLP, 401 9TH STREET, NW, SUITE 900, WASHINGTON, DC, 20004-2128, US

(21) Appl. No.: 12/667,403

(22) PCT Filed: Jun. 30, 2008
(86) PCT No.: PCT/IB2008/001699

§ 371 Date: Aug. 5, 2010

(30) Foreign Application Priority Data
Jul. 2, 2007 (ZA) 2007/05591

(51) Int. Cl. E04C 2/26; E04C 2/20; E04C 2/22; B44F 9/02; E04B 1/92; E04C 2/40; B29C 43/00; B29C 70/00; B29C 45/00; B29C 47/00

(52) U.S. Cl. 52/309.17; 52/309.1; 52/309.13; 52/313; 52/515; 52/580; 264/129; 264/134

(57) ABSTRACT

This invention relates to a construction element (1) which is suitable for cladding the walls of buildings. The element (1) is made of synthetic plastics material, has a generally planar exterior decorable face (2) and a hollow interior face opposite the exterior face, and is preferably fire resistant, fibre reinforced, UV-stabilized, biocidal and formed by moulding. The exterior face (2) is decorated with a decorable finish which is in the form of a sprayable mixture of a polymer or resin and any one or more of a has formations (5, 7, 9) located within the hollow which facilitate securemtne of the element to a wall.

### FIELD OF THE INVENTION

This invention relates to a construction element and to a method of manufacturing and using the same.

### BACKGROUND TO THE INVENTION

Wall cladding is carried out on both interior and exterior walls of building to meet a number of design objectives. Among these, durability and the improvement of appearance are usually the prime requirements. Additionally, wall cladding may provide improved thermal insulation and exterior cladding may provide better weather resistance of the building walls. Many buildings have cladding blocks made from natural stone, sandstone or quartzite but such cladding is expensive and weathers thus negating one of its functions namely durability.

Traditionally, the exterior face of cladding may either have a smooth or rough surface and is secured to a wall it protects or decorates

Cladding is also substantially thinner than a wall it is secured to and several methods of securing cladding to walls are known and are used. They are usually anchored to the wall and secured to each other and to the wall by a layer of cement. Some methods make use of grooves in lower and upper edges of each block, into which a cross-shaped connecting element is inserted. In addition, some of these methods use planking and do not become permanently stable until concrete is poured behind the cladding blocks.

Some known methods also utilise dry cladding with bridging members as brackets. These methods, however, require individual attachment of each bridging bracket to the wall being faced, an arrangement requiring some skill.

All these known cladding methods, have limitations ranging from weight of the cladding, the expense of the cladding and the cladding degrading and/or dissolving due to acid rain and other pollutants.

### OBJECT OF THE INVENTION

It is an object of this invention to provide a construction element and a method of manufacturing and using said construction element which at least partly alleviates the above-mentioned disadvantages.

### SUMMARY OF THE INVENTION

In accordance with this invention there is provided a construction element comprising a synthetic plastics material element having decorable exterior face, the construction element being securable in use to a wall to display its decorable exterior face.

There is provided for the element to be generally planar and preferably parallelepipedical, alternatively for it to have any shape conventionally used in building operations.

There is further provided for the generally planar construction element to have a decorative finish on its exterior decorable face; and for said finish to be spray coated onto the face.

Further, the spray coated decorative finish may be liquid stone cementitious material; alternatively sandstone and resin, preferably a polymer, blend; further alternatively a cobble and resin, preferably a polymer, blend; still further alternatively glass beads mixed with a resin, preferably a polymer. There is also provided for the spray coated decorative finish to be a quartzite and resin, preferably a polymer, mixture. Alternatively the spray coated decorative finish may simulate a wood grain finish.

There is also further provided for the plastics material to be a synthetic resin; for the synthetic resin to be polypropylene (PP), alternatively polyvinylchloride (PVC); further alternatively high impact polystyrene (HIPS), and further alternatively acrylonitrile butadiene styrene (ABS). There is also provided for the plastics material to be fire resistant; for it to indlude UV stabilizers; and for the plastics material to be reinforced, preferably with a fibrous material. There is further provided for the plastics material to be coated with resin and/or for it to be coated or impregnated with at least one biocide.

There is further provided for the construction element have a hollow interior face opposite the decorable exterior face.

There is further provided for the hollow construction element to have moulded formations within the hollow interior face, said formations serving, in use, to facilitate securement of the construction element to a plastered wall. There is also provided for the formations to include at least one diagonal rib and for at least one tubular formation.

According to another aspect of the invention there is provided a method of manufacturing a construction element comprising moulding a synthetic plastics material and applying a decorative finish to at least its operatively exterior face, the construction element being securable, in use, to a wall to display its decorated exterior face.

There is further provided for the element to be generally planar and preferably parallelepipedical, alternatively for it to have any shape conventionally used in building operations.

There is further provided for the decorative finish on its exterior decorable face; to be spray coated onto the face. Alternatively there is provided for the decorative finish to be moulded when the construction element is moulded.

There is also provided, in the case of a spray coated decorative finish, the finish to be a liquid stone cementitious material; alternatively sandstone and resin, preferably a polymer, blend; further alternatively a cobble and resin, preferably a polymer, blend; still further alternatively glass beads mixed with a resin, preferably a polymer. There is also provided for the spray coated decorative finish to be a quartzite and resin, preferably a polymer, mixture. Alternatively the spray coated decorative finish may simulate a wood grain finish.

There is also further provided for the plastics material to be a synthetic resin; for the synthetic resin to be polypropylene (PP), alternatively polyvinylchloride (PVC); further alternatively high impact polystyrene (HIPS), and further alternatively acrylonitrile butadiene styrene (ABS). There is also provided for the plastics material to be fire resistant; for it to indlude UV stabilizers; and for the plastics material to be reinforced, preferably with a fibrous material. There is further provided for the plastics material to be coated with resin and/or for it to be coated or impregnated with at least one biocide.

There is further provided for the construction element have a hollow interior face opposite the decorable exterior face.

There is further provided for the hollow construction element to have moulded formations within the hollow interior face, said formations serving, in use, to facilitate securement of the construction element to a plastered wall. There is also provided for the formations to include at least one diagonal rib and for at least one tubular formation.

There is further provided for the synthetic plastics material to be injection moulded, alternatively rotor moulded, further alternatively polystyrene moulded, still further alternatively compression moulded and still further alternatively vacuum or extruded.

There is further provided for the plastics material to be reinforced with a fibrous material, preferably glass fibres.

### BRIEF DESCRIPTION OF THE DRAWINGS

Embodiments of the invention will be described below by way of example only and with reference to the accompanying drawings in which:

FIG. 1 is an isometric view of a tap or decorative face of one embodiment of a construction element according to the invention;

FIG. 2 is an isometric view of one embodiment of a construction element according to the invention views from behind;

FIGS. 3 and 4 are two further embodiments of the decorative face of a element according to the invention; and

FIGS. 5A to D are alternative embodiments of the rear hollow of construction elements according to the invention.

### DETAILED DESCRIPTION OF THE DRAWINGS

Referring to FIG. 1, a construction element (1) comprises a generally planar, synthetic plastics material, parallelepipedical element having a decorable exterior face (2). In sue, the element (1) is securable to a wall (not shown) to display its decorable exterior face (2). In this embodiment the decorable exterior face (2) is slightly roughened and the element (1) is sprayed with a comminuted sandstone and mortar mixture so that its exterior face (2) simulates a rough hewn sandstone block.

In use, the element (1) is secured to a brick or mortar plastered wall by mortar or by any suitable adhesive. A multiplicity of elements (1) are so secured to the wall and aligned relative to one another to create a visual impression that the wall is made of rough hewn sandstone blocks.

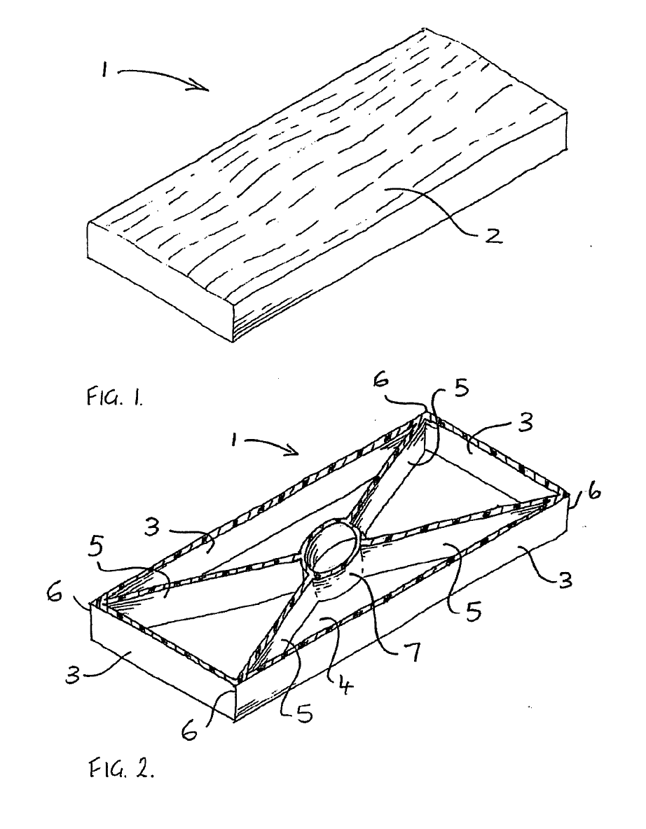

Referring particularly to FIG. 2, the hollow rear of the element of FIG. 1 is shown. The hollow is formed from the upstanding side walls (3) of the element (1). To provide rigidity to the element (1) and to increase the surface area of the rear face (4) so facilitate securement to a wall, upstanding diagonal ribs (5) lead from each corner (6) to meet at a centrally positioned tubular formation (7).

The element (1) is manufactured by moulding a synthetic plastics resin. This can be done in a factory environment or on a building site. In a preferred method the element (1) is injection moulded although it can also be rotor moulded or vacuum formed.

Once the resin has cured a decorative coating is sprayed on the element although, depending on the type of finish that is desired, it could be applied with a brush or dipped.

Finishes that can be applied to the element include natural stone finishes such as granite, sandstone or quartzite, marble finishes and artificial finishes which are glass chips that are added to the coating.

The plastics material is a resinous material and can have one or more of a UV stabilizer, a biocide and/or natural sand or stone added to it before it is moulded.

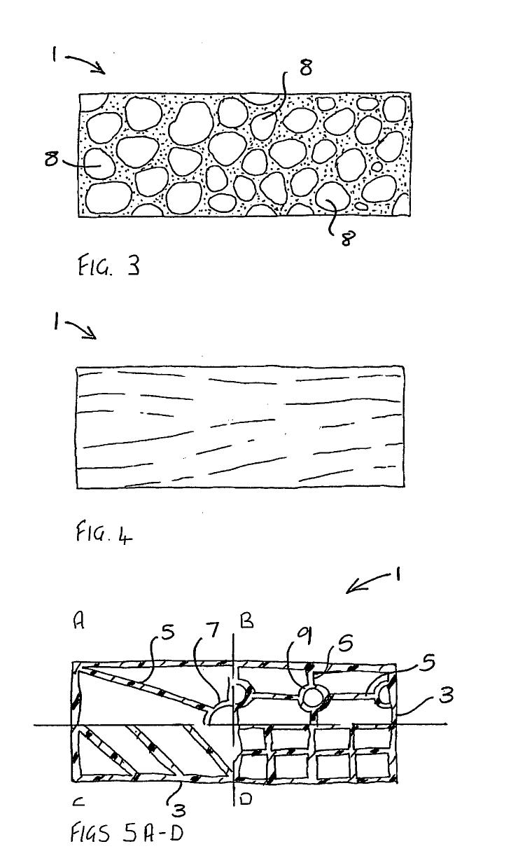

Referring now to FIGS. 3 and 4, alternate embodiments of finishes that can be simulated are shown. In FIG. 3 the finish is intended to resemble a multiplicity of irregularly shaped stones (8) and it is achieved by sculpting the mould or it can be achieved by placing small stones in the mould although this will add to the weight of the element (1) although it is envisaged that such elements could be used as garden paving.

In FIG. 4 a wood grain finish is simulated and it is envisaged that such elements (1) can be used on interior walls of buildings to provide an aesthetically pleasing appearance.

Referring to FIG. 5, four different configurations of ribs for facilitating securement of an element (1) to a wall (not shown) are illustrated as 5A to 5D. The arrangement illustrated in FIG. 5A has already been described with reference to FIG. 2.

In FIG. 5B the ribs (5) are at right angles to the side walls (3) and have a tubular formation (9) at each of their intersections. The ribs (5) in FIG. 5C are diagonal while the ribs (5) in FIG. 5D form a series of squares on the underside of the decorative face of the element (1).

1. A construction element comprising a synthetic plastics material element having decorable exterior face, the construction element being securable in use to a wall to display its decorable exterior face.

2. A construction element as claimed in claim 1 in which the element is generally planar.

3. A construction element as claimed in claim 1 or in claim 2 in which the element is parallelepipedical.

4. A construction element as claimed in claim 1 in which the element has any shape conventionally used in building operations.

5. A construction element as claimed in any one of the preceding claims in which in which the element has a decorative finish on its exterior decorable face.

6. A construction element as claimed in claim 5 in which the decorative finish is spray coated onto the exterior decorable face.

7. A construction element as claimed in claim 6 in which the decorative finish is a liquid stone cementitious material.

8. A construction element as claimed in claim 6 in which the decorative finish is a sandstone and resin blend.

9. A construction element as claimed in claim 6 in which the decorative finish is a cobble and resin blend.

10. A construction element as claimed in claim 6 in which the decorative finish is a glass bead and resin blend.

11. A construction element as claimed in claim 6 in which the decorative finish is a quartzite and resin mixture.

12. A construction element as claimed in any one of claims 8 to 11 in which the resin is a polymer.

13. A construction element as claimed in claim 6 in which the decorative finish is a in which the spray coated decorative finish simulates a wood grain finish.

14. A construction element as claimed in any one of the preceding claims in which the plastics material is a synthetic resin.

15. A construction element as claimed in claim 14 in which the synthetic resin is selected from the group consisting of polypropylene (PP), polyvinylchloride (PVC); high impact polystyrene (HIPS), and acrylonitrile butadiene styrene (ABS).

16. A construction element as claimed in any one of the preceding claims in which the plastics material is fire resistant.

17. A construction element as claimed in any one of the preceding claims in which the plastics material includes UV stabilizers.

18. A construction element as claimed in any one of the preceding claims in which the plastics material is reinforced.

19. A construction element as claimed in claim 18 in which the the plastics material is reinforced with a fibrous material.

20. A construction element as claimed in any one of the preceding claims in which the plastics material to be coated with resin and/or coated or impregnated with at least one biocide.

21. A construction element as claimed in any one of the preceding claims in which the construction element has a hollow interior face opposite the decorable exterior face.

22. A construction element as claimed in claim 21 in which the hollow interior face of construction element has moulded formations within it, said formations serving, in use, to facilitate securement of the construction element to a plastered wall.

23. A construction element as claimed in claim 22 in which the formations to include at least one diagonal rib and at least one tubular formation.

24. A method of manufacturing a construction element comprising moulding a synthetic plastics material and applying a decorative finish to at least its operatively exterior face, the construction element being securable, in use, to a wall to display its decorated exterior face.

25. A method of manufacturing a construction element as claimed in claim 24 in which the element is generally planar.

26. A method of manufacturing a construction element as claimed in claim 25 in which the element is parallelepipedical.

27. A method of manufacturing a construction element as claimed in claim 25 in which the element has any shape conventionally used in building operations.

28. A method of manufacturing a construction element as claimed in any one of claims 24 to 27 in which the decorative finish on its exterior decorable face is spray coated onto the face.

29. A method of manufacturing a construction element as claimed in any one of claims 24 to 27 in which the decorative finish on its exterior decorable face is moulded when the construction element is moulded.

30. A method of manufacturing a construction element as claimed in claim 28 in which the finish is a liquid stone cementitious material.

31. A method of manufacturing a construction element as claimed in claim 28 in which the finish is a sandstone and resin blend.

32. A method of manufacturing a construction element as claimed in claim 28 in which the finish is a cobble and resin blend.

33. A method of manufacturing a construction element as claimed in claim 28 in which the finish is a glass bead and resin mixture.

34. A method of manufacturing a construction element as claimed in claim 28 in which the finish is a quartzite and resin mixture.

35. A method of manufacturing a construction element as claimed in any one of claims 28 or 30 to 32 in which the resin is a polymer.

36. A method of manufacturing a construction element as claimed in any one of claims 28 or claim 29 in which the finish simulates a wood grain finish.

37. A method of manufacturing a construction element as claimed in any one of claims 24 to 36 in which the plastics material is a synthetic resin.

38. A method of manufacturing a construction element as claimed in claim 37 the synthetic resin is selected from the group consisting of: polypropylene (PP), polyvinylchloride (PVC); high impact polystyrene (HIPS), and acrylonitrile butadiene styrene (ABS).

39. A method of manufacturing a construction element as claimed in any one of the claims 24 to 38 in which the plastics material is fire resistant.

40. A method of manufacturing a construction element as claimed in any one of the claims 24 to 39 in which the plastics material includes UV stabilizers.

41. A method of manufacturing a construction element as claimed in any one of the claims 24 to 40 in which the plastics materialis reinforced.

42. A method of manufacturing a construction element as claimed in claim 41 in which the plastics material is reinforced with a fibrous material.

43. A method of manufacturing a construction element as claimed in any one of the claims 24 to 42 in which the plastics material is coated with resin.

44. A method of manufacturing a construction element as claimed in any one of the claims 24 to 43 in which the plastics material is coated or impregnated with at least one biocide.

45. A method of manufacturing a construction element as claimed in any one of the claims 24 to 44 in which the construction element has a hollow interior face opposite its decorable exterior face.

46. A method of manufacturing a construction element as claimed in claim 45 in which the element has moulded formations within the hollow interior face, said formations serving, in use, to facilitate securement of the construction element to a plastered wall.

47. A method of manufacturing a construction element as claimed in claim 46 in which the formations to include at least one diagonal rib and at least one tubular formation.

48. A method of manufacturing a construction element as claimed in any one of the claims 24 to 47 in which the synthetic plastics material is injection moulded to form the element.

49. A method of manufacturing a construction element as claimed in any one of the claims 24 to 47 in which the synthetic plastics material is rotor moulded to form the element.

50. A method of manufacturing a construction element as claimed in any one of the claims 24 to 47 in which the synthetic plastics material is polystyrene moulded to form the element.

51. A method of manufacturing a construction element as claimed in any one of the claims 24 to 47 in which the synthetic plastics material is compression moulded to form the element.

52. A method of manufacturing a construction element as claimed in any one of the claims 24 to 47 in which the synthetic plastics material is vacuum formed to form the element.

53. A method of manufacturing a construction element as claimed in any one of the claims 24 to 47 in which the synthetic plastics material is extruded to form the element.

54. A method of manufacturing a construction element as claimed in any one of the claims 24 to 53 in which the synthetic plastics material is reinforced.

55. A method of manufacturing a construction element as claimed in claim 54 in which the synthetic plastics material is reinforced with a fibrous material.

56. A method of manufacturing a construction element as claimed in claim 54 in which the fibrous material is glass fibres.
